(19) United States
(12) Patent Application Publication
(10) Pub. No.: US 2013/0164209 A1
(43) Pub. Date: Jun. 27, 2013

(54) METHOD FOR PREPARING GRAPHENE RIBBONS WHERE STRUCTURE IS CONTROLLED

(71) Applicants: Jae-Kap LEE, Seoul (KR); Kyoung-Il LEE, Seoul (KR); So-Hyung LEE, Seoul (KR)

(72) Inventors: Jae-Kap LEE, Seoul (KR); Kyoung-Il LEE, Seoul (KR); So-Hyung LEE, Seoul (KR)

(21) Appl. No.: 13/772,999

(22) Filed: Feb. 21, 2013

Related U.S. Application Data
(63) Continuation-in-part of application No. 12/909,958, filed on Oct. 22, 2010, now abandoned.

(30) Foreign Application Priority Data
Oct. 23, 2009 (KR) 10-2009-0101389

(51) Int. Cl. C01B 31/04

(52) U.S. Cl. CPC C01B 31/0446
USPC 423/448; 264/29.1

(57) ABSTRACT

Disclosed is a method for fabricating graphene ribbons which are high-functional carbon materials. Provided a method of fabricating graphene ribbons, including (a) preparing a graphene helix carbon structure which is formed by spiral growing of a unit graphene , and (b) applying energy to the carbon structure to obtain ribbon-shaped graphenes.

### CROSS REFERENCED TO RELATED APPLICATION

This application is a continuation-in-part of U.S. patent application No. 12/909,958 filed on Oct. 22, 2010, now pending, which claims the benefit under 35 U.S.C. §119(a) of a Korean Patent Application No. 10-2009-0101389, filed on Oct. 23, 2009 with the Korean Intellectual Property Office. The entire disclosures of the related applications are hereby incorporated by reference.

### BACKGROUND OF THE INVENTION

1. Field of the Invention

The present invention relates to a high-functional carbon material, and more particularly, to a method of fabricating graphene ribbons from a carbon structure.

2. Background of the Invention

Graphene refers to a single layer of honeycombed carbon atoms (two-dimensional net with a thickness of about 4 Å, which is a basic unit of C₆₀, carbon nanotube and graphite. Graphite, which is a typical layered material, is a carbon building block formed by two kinds of bond. The covalent bond between carbon atoms (referred to as a “sigma bond”) within each graphene layer is strong while the bond (van der Waals force) between graphene layers (referred to as a “pi bond”) is very weak. Due to the asymmetrical bond strength, there is a possibility that single-layered graphene having an atomic thickness (˜4 Å) can be separated from graphite and can be sustained in nature. There have been many reports on physical properties of graphene, which are better than those of carbon nanotubes. As a method of obtaining such graphene, mechanical cleavage in which graphene is detached from graphite having an AB-layered structure using an adhesive tape was first reported in 2004. However, this method has a problem that the yield is very low.

Thereafter, there have been several reports on chemical vapour deposition (CVD) approach, in which graphene is epitaxially grown on a metal substrate in a CVD condition, and is moved onto another substrate later, or the like. However, the CVD method has critical two problems. First, obtaining single-layered graphene is very difficult because formation of layered graphene (i.e., graphite) is energetically stable. Next, graphene deposits are not a single crystalline, but polycrystalline.

Graphene exhibits different electrical properties according to its edge structures (i.e., zigzag or armchair). For example, zigzag graphene shows half-metallic property which is ideal for fabrication of an electronic device. Thus, controlling edge structure of graphene is very important. However, it is impossible that we control the edge structure of graphene ribbons at the stage of fabrication with any of the foregoing existing methods.

### SUMMARY OF THE INVENTION

Therefore, an object of the present invention is to provide a method of fabricating single-layered pure graphene ribbons (thickness 4 Å) having a zigzag or armchair structure in a simple manner and in a large quantity.

The foregoing objective may be accomplished by a method of fabricating graphene ribbons, including (a) preparing a graphene helix carbon structure (carbon structure in the form of a graphene helix) which is formed by spiral growth of a unit graphene (graphene nucleus) in a chemical vapor deposition (CVD) condition, and (b) applying energy to the graphene helix carbon structure to unroll it into graphene ribbons.

According to the present invention, graphene ribbons having better physical properties than commercialized carbon nanotubes can be fabricated in a simple manner and in a great quantity. Also, graphene ribbons having wide surface can be fabricated in a simple manner by unrolling the graphene helix carbon structure grown up from the unit graphene. The graphene ribbons obtained by the present invention may be applicable to various fields such as a next-generation electronic device including a field effect transistor (FET), a bio-sensor, a gas sensor, and the like.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1A is a schematic diagram illustrating the helical growth of a unit graphene, resulting in formation of the graphene helix carbon structure which is the starting material for graphene ribbons in the present invention; and

FIG. 2 is a view illustrating the process of fabricating (zigzag) graphene ribbons from the graphene helix carbon structure according to an embodiment of the present invention.

### DETAILED DESCRIPTION OF THE INVENTION

A method of fabricating graphene ribbons according to the present invention may be implemented by comprising preparing a graphene helix carbon structure, resulted from spiral growth of unit graphene in a chemical vapor deposition (CVD) condition, and applying energy to the carbon structure to obtain ribbon-shaped graphenes.

The graphene helix carbon structure (starting material) may have a zigzag or armchair structure in the dimension of 0.3-10 nm in diameter and 100 nm in length.

On the other hand, the length of the graphene ribbon (obtained material) may be less than the length of the graphene helix carbon structure, and the width thereof may be less than 5.3 times of the diameter of the carbon structure, and the graphene ribbon may have a zigzag or armchair structure.

The energy to be applied to the carbon structure may be ultrasonic energy or thermal energy.

In addition, the method may further include the step of milling and cutting the carbon structure, prior to applying energy. Milling may be carried out by wet milling method or dry milling method, including mechanical milling such as roll milling, ball milling, attrition milling, planetary milling, zet milling, screw mixing, but is not limited thereto.

The term “unit graphene” refers to a graphene precursor to grow to a graphene helix carbon structure, i.e., helically scrolled graphene ribbon composed of single layered carbon atoms. Unit graphene determines the structure of the graphene helix, zigzag or armchair configuration.

The present invention will be described in more detail with reference to the attached drawings.

### Preparing a Carbon Structure

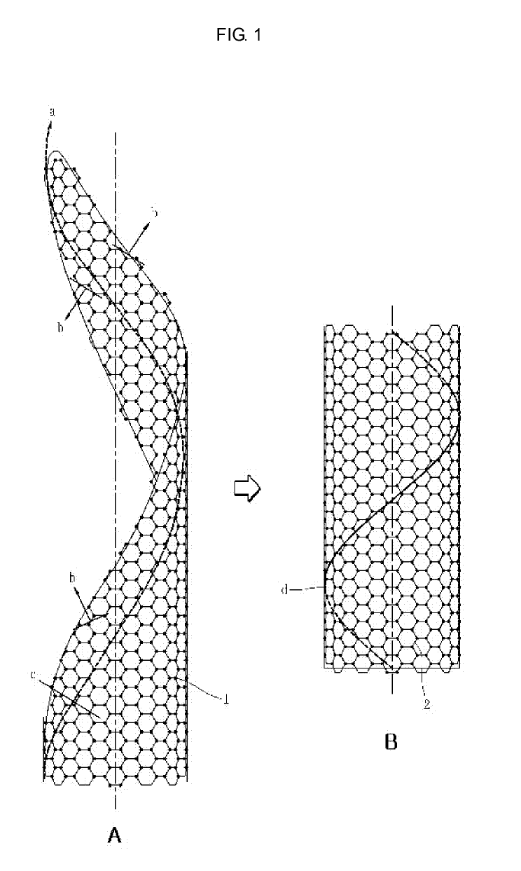

For a carbon structure used in the present invention, ribbon-shaped unit graphene is spirally grown through a chemical vapour deposition (CVD) process, resulting in formation of a graphene helix (see FIG. 1). The graphene helix carbon structure (open graphene structure) can be seen as cylindrical graphene.

The spiral growth of ribbon-shaped unit graphene is advantageous in terms of energy, compared with the (tubular) growth of a cylindrical graphene, i.e., single-wall carbon nanotubes (SWNT) (closed graphene structure). The strain energy of the graphene helix carbon structure is less by about ¼ than that of SWNT.

Furthermore, the spiral shape of the starting material makes the graphene structure exist independently, i.e., without being layered. If several flat graphene layers exit together they should form a layered structure, i.e., graphite, due to the van der waals force working between graphene layers. Therefore, if the carbon structure is formed with a layered structure, then a single-layered pure graphene cannot be obtained.

The graphene helix carbon structure can exist in the zigzag or the armchair configuration, depending on the configuration of unit graphene. FIG. 1B shows an “armchair graphene helix”, resulted from the spiral growth of a “zigzag unit graphene” (FIG. 1A), of which the growth direction is perpendicular to the zigzag line (c). Also, an zigzag graphene helix can be formed if armchair unit graphene, of which the growth direction is perpendicular to the armchair line, is initiated for the spiral growth. In summary, the armchair graphene helix is composed of a zigzag graphene ribbon which has helically grown from zigzag unit graphene, while the zigzag graphene helix is composed of an armchair graphene ribbon which has helically grown from armchair unit graphene, i.e., a graphene ribbon having armchair-structured edge (or zigzag-structured edge) is obtained from a unit graphene having zigzag-structured edge (or armchair-structured edge.) Thus, the structure of graphene ribbons, zigzag or armchair, can be controlled by selection of the type of the graphene helix carbon structure.

It is well-known that the edge structure of graphene does critically effect on its electrical properties. The invention provides a new way of controlling the edge structure of the resulting graphene ribbons at their fabrication stage.

The dimension of the graphene helix carbon structure is 0.3-10 nm, preferably 0.4-5 nm in diameter, and several hundreds of nm to several μm, preferably 100 nm to 5 μm in length.

### Obtaining Graphene Ribbons

Next, energy is applied to the graphene helix carbon structure prepared as described above, to unroll it into a graphene ribbon, thereby obtaining pure (single-layered) graphene ribbons.

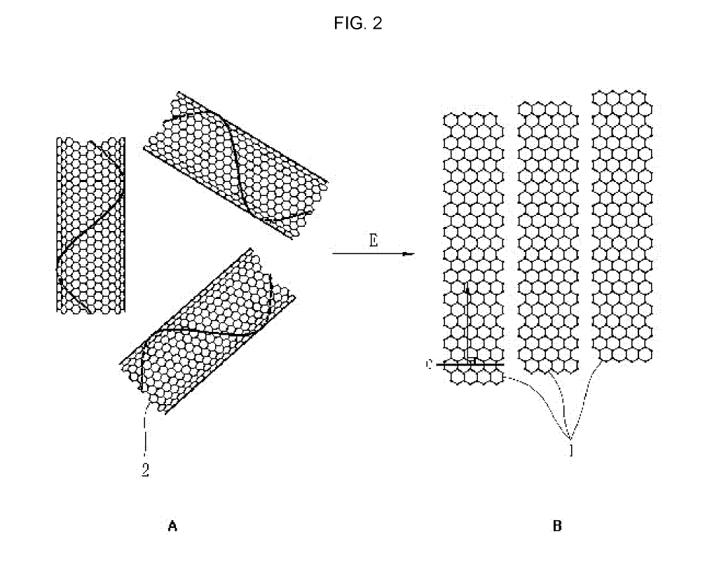

For the energy applied to the graphene helix (“E” in FIG. 2), ultrasonic energy or thermal energy can be used.

In case of applying ultrasonic energy, the graphene helix samples are treated in a ultrasonic bath where solution may be typically alcohol including isopropyl alcohol. The transformation ratio (%), i.e., the ratio of the numbers of the samples transformed from the graphene helices to graphene ribbons, increased with treatment time and applied power, as shown in Table 1. The numbers in parentheses show the transformation ratio (%) in the case of further process of milling treatment.

TABLE 1
(Unit: %)

| Ultrasonic | Treatment Time (hr) | | | | |
|---|---|---|---|---|---|
| Power (W) | 2 | 4 | 6 | 8 | 10 |
| 300 | 1(5) | 3(11) | 6(14) | 8(21) | 11(32) |
| 500 | 5(10) | 12(19) | 20(30) | 27(62) | 33(81) |

On the other hand, when thermal energy is applied, heat treatment is carried out between 500□ and 2000□, preferably 1500□ and 2000□. And the treatment is preferably carried out subsequent to dispersing a carbon structure into a single layer on a substrate in order to prevent forming graphite. As illustrated in Table 2, it was found that the transformation ratio increased with thermal treatment temperature treatment time.

TABLE 2

| (Unit: %) | |
|---|---|
| Thermal Treatment | Treatment Time (hr) |

| Temperature (° C.) | 1 | 2 |
|---|---|---|
| 500 | 1(5) | 3(11) |
| 1000 | 12(18) | 15(22) |
| 1500 | 42(51) | 52(67) |
| 2000 | 91(95) | 100(100) |

The transformation ratio may be increased by an additional mechanical milling of the pristine carbon structure before the energy treatments because the milling process can shorten the graphene helices, resulting in decreasing the energy barrier for unrolling.

The energy applied to a carbon structure is not limited to the two kinds of treatment, the ultrasonic energy and thermal energy, and any other method such as ion beam or the like may be used.

The width of fabricated graphene ribbons may be up to about 5.3 times of the diameter of carbon structure (less than 5 nm), which is the raw material, and also may be less than about 30 nm.

Hereinafter, although the present invention will be described in detail through examples, those examples are merely provided to more clearly understand the present invention, but not provided for the purpose of limiting the scope of the present invention, and consequently, the true technical protective scope of the present invention should be determined based on the technical spirit of the appended claims.

### Example 1

Graphene ribbons were fabricated by using a graphene helix carbon structure as a pristine material, resulted from the spiral growth of zigzag unit graphene (nuclei) in chemical vapour deposition (CVD) condition. The helical carbon structure was 1-4 nm in diameter, and 1 μm in length. The samples were treated in an ultrasonic bath and the transformation ratio from the carbon structure to graphene ribbons were increased with treatment time and ultrasonic power, as illustrated in Table 1. The solution used for ultrasonic treatment was alcohol. Graphene ribbons obtained were confirmed to be in the zigzag configuration, and 10-25 nm in width and less than 1 μm in length.

### Example 2

The graphene helix carbon structure samples were pretreated by ball-milling for 10 minutes, before ultrasonic treatment (power 500 W) in alcohol for 4 hours. The transformation ratio is illustrated as parentheses in Table 1. Graphene ribbons obtained were confirmed to be in the zigzag configuration, and 10-25 nm in width and 50-300 nm in length.

### Example 3

Graphene ribbons were fabricated by applying energy to the graphene helices. The samples were dispersed not to be layered on a mirror polished ceramic substrate. The sample set was placed into a high vacuum furnace and heated in the range of 500-2000° C. The transformation ratio increased with treatment temperature and time as illustrated in Table 2. Graphene ribbons obtained were confirmed to be in the zigzag configuration, and 10-25 nm in width and less than 1 μm in length.

Though the present invention has been described with reference to preferred embodiments, these are merely illustrative, and it should be understood by those skilled in the art that various modifications and equivalent other embodiments of the present invention can be made.

What is claimed is:

1. A method for fabricating a graphene ribbon, comprising:
(a) preparing a graphene helix carbon structure which is formed by spiral growth of a unit graphene; and
(b) applying energy to the graphene helix carbon structure to obtain the graphene ribbon.

2. The method of claim 1, wherein the graphene ribbon is a single layered graphene ribbon.

3. The method of claim 1, wherein the graphene ribbon has a zigzag configuration.

4. The method of claim 1, wherein the graphene ribbon has an armchair configuration.

5. The method of claim 1, wherein a structure of the graphene ribbon is determined by a structure of the unit graphene.

6. The method of claim 1, wherein the carbon structure is 0.3-10 nm in diameter and 100 nm-5 μm in length.

7. The method of claim 1, wherein the length of the graphene ribbon is less than the length of the carbon structure, and the width thereof is less than 5.3 times of the diameter of the carbon structure.

8. The method of claim 1, wherein the graphene ribbon has zigzag structure or armchair structure.

9. The method of claim 1, wherein the energy is ultrasonic energy or thermal energy.

10. The method of claim 9, wherein the ultrasonic energy is applied to the graphene helix carbon structure in a solution.

11. The method of claim 9, wherein the thermal energy is applied by heat treatment of 500-2000□.

12. The method of claim 1, further comprising:
milling and cutting the carbon structure between the steps (a) and (b).

13. The method of claim 1, wherein the step (b) comprises:
(i) dispersing the graphene helix carbon structure into a single layer on a substrate; and
(ii) applying energy to the dispersed graphene helix carbon structure to obtain the graphene ribbon.
